(19) United States
(12) Patent Application Publication
(10) Pub. No.: US 2024/0339677 A1
(43) Pub. Date: Oct. 10, 2024

(54) RECHARGEABLE LITHIUM BATTERY ASSEMBLY

(71) Applicant: SHENZHEN ORIENTAL WILLING NEW ENERGY CO., LTD, Shenzhen (CN)

(72) Inventor: KUNLI WANG, Shenzhen (CN)

(21) Appl. No.: 18/543,531

(22) Filed: Dec. 18, 2023

(30) Foreign Application Priority Data
Apr. 6, 2023 (CN) 202320730794.1

(51) Int. Cl. H01M 10/42; H01M 10/052; H01M 10/46; H01M 10/48; H01M 50/107; H01M 50/152; H01M 50/55; H01M 50/559

(52) U.S. Cl. CPC H01M 10/425; H01M 10/052; H01M 10/46; H01M 10/488; H01M 50/107; H01M 50/152; H01M 50/55; H01M 50/559; H02J 7/0045; H02J 50/10

(57) ABSTRACT

The present disclosure provides a rechargeable lithium battery, including a housing, a battery cell assembly, and a top cover assembly. The cell assembly has a positive end and a negative end. The top cover assembly includes a circuit board encapsulated on the outside of the top cover, including the circuit board, and a charging plug. The charging plug extends outside the top cover and may be folded and stored in the top cover. The battery comes with a charging plug, changing the use of the current rechargeable battery requires additional wiring mode, greatly facilitating the use of the user, the charging plug is foldable, the storage state will not affect the normal use of the battery. The overall simplicity of this structure. cost-effective, to meet the needs of a variety of application scenarios on the current market.

### CROSS-REFERENCE TO RELATED APPLICATIONS

This application claims priority to Chinese Patent Application No. 202320730794.1 filed on Apr. 6, 2023, which is hereby incorporated by reference in its entirety.

### TECHNICAL FIELD

The present disclosure relates to a lithium battery assembly, and more particularly to a rechargeable lithium battery assembly which may be conveniently charging and discharging.

### BACKGROUND

As a source of energy, portable lithium battery has a stable voltage and current, and its performance is stable and reliable, and is widely used in all aspects of modern social life. Especially cylindrical batteries, such as common lithium battery models 18650 or 21700, which is more common than ordinary size 5 or 7 batteries, with a more suitable for lithium battery capacity and charge-discharge law of battery type. The battery type has gradually formed a commercial ecology of lithium batteries.

A common rechargeable battery includes an external charger that matches the rechargeable battery to charge it, and a charging circuit integrated with the rechargeable battery (called a rechargeable battery assembly) is directly connected to the power supply. It's charging. Compared with an external charging device, a rechargeable battery with a built-in charging circuit that can be directly connected to a power source is more portable and less expensive. Currently batteries are charged using traditional charging methods, which are not suitable in certain situations and need to be used with a data cable. Even when new batteries are available to replace them, they are discarded because of their high cost. Therefore there is an urgent need for cost effective transitional rechargeable batteries.

### SUMMARY

In view of this, the present disclosure is designed to provide a rechargeable lithium battery assembly to improve connection reliability.

The portable and rechargeable lithium battery assembly has a housing, a battery cell assembly, and a top cover assembly encapsulated with one end of the housing. The cell assembly has a main body, a positive end and a negative end in the direction of the top cover assembly. The top cover assembly has a circuit board assembly and a top cover assembly for encapsulation, the circuit board assembly being electrically connected to the positive end and the negative end of the cell assembly. The circuit board assembly has a circuit board, a charging plug provided on the circuit board and electrically connected thereto, the charging plug being extendable outside the top cover assembly and foldable for storage on the top cover assembly.

In another aspect, the charging plug further has a foldable flexible wire, and a type-C plug is provided at one end of the flexible wire.

In another aspect, the flexible wire has a ring-shaped central portion, two branching arms extending from the central portion to both sides, the type-c plug being provided on one of the two branching arms. The top cover assembly has a tab overlaid with the ring-shaped central portion of the flexible wire and two slots for holding the branching arms, the central area of the tab having a central hole.

In another aspect, one of the two branching arms is provided with a touch switch and/or LED light and/or a power indicator mark.

In another aspect, the circuit board assembly further includes a wireless charging coil provided between the circuit board and the top cover assembly, the wireless charging coil electrically connected to the circuit board, and a wireless charging logo is provided on the top surface of the top cover assembly.

In another aspect, the wireless charging coil is a magnetic suction type wireless charging coil.

In another aspect, a positive cap is located at the center of the circuit board of the top cover assembly and is electrically connected to the positive end of the battery cell assembly. The positive cap is received in the central hole of the tab of the top cover assembly, a negative ring is stacked in the ring-shaped central portion of the flexible wire, and the positive cap and the negative ring being insulated and spaced apart by the tab.

In another aspect, the circuit board is provided with a downwardly extending electrical connection unit, the electrical connection unit is electrically connected by contacting with the positive end of the battery cell assembly.

In another aspect, the electrical connection unit has a nut and a stud, the nut is removably connected to the stud.

In another aspect, a resilient conductive post is provided extending downwardly at the bottom edge of the circuit board. The resilient conductive post abuts against the negative end of the battery cell assembly.

The rechargeable lithium battery assembly provided by the present disclosure has two parts that may be disassembled and connected. while disassembled, the battery body may be used as a power source to supply external electronic products via the charging plug which is accommodated on the top cover assembly.

### BRIEF DESCRIPTION OF DRAWINGS

Many aspects of the embodiments can be better understood with reference to the following drawings. The components in the drawings are not necessarily drawn to scale, the emphasis instead being placed upon clearly illustrating the principles of the embodiment.

FIG. 1 is an isometric view of a rechargeable lithium battery assembly in accordance with an exemplary embodiment of the present disclosure.

FIG. 2 is an isometric exploded view of the rechargeable lithium battery assembly in FIG. 1, viewed from another aspect.

FIG. 3 is an isometric view of a circuit board of the rechargeable lithium battery assembly in accordance with an exemplay embodiment of the present disclosure.

### DESCRIPTION OF EMBODIMENTS

In the following description of the disclosure and embodiments, reference is made to the accompanying drawings in which it is shown by way of illustration of specific embodiments that can be practiced. It is to be understood that other embodiments and examples can be practiced and changes can be made without departing from the scope of the disclosure.

Although the following description uses terms “first,” “second,” etc. to describe various elements, these elements should not be limited by the terms. These terms are only used to distinguish one element from another. For example, a first input could be termed a second input, and, similarly, a second input could be termed a first input, without departing from the scope of the various described examples. The first input and the second input can both be outputs and, in some cases, can be separate and different inputs.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

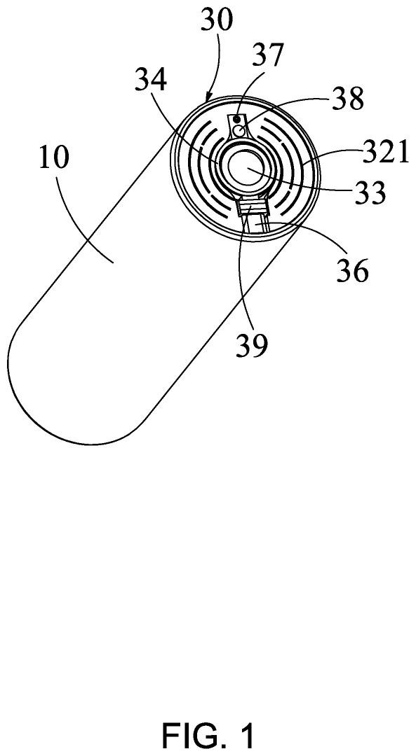

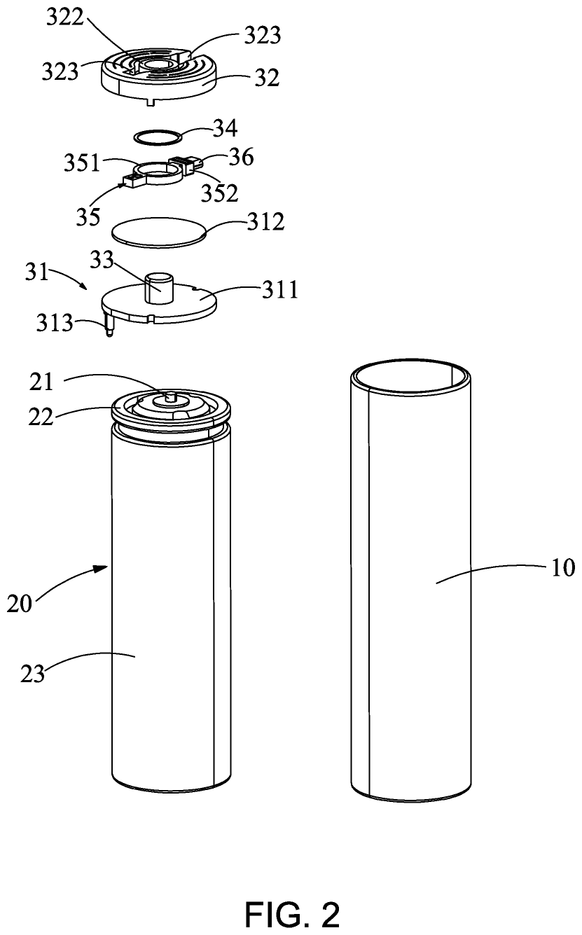

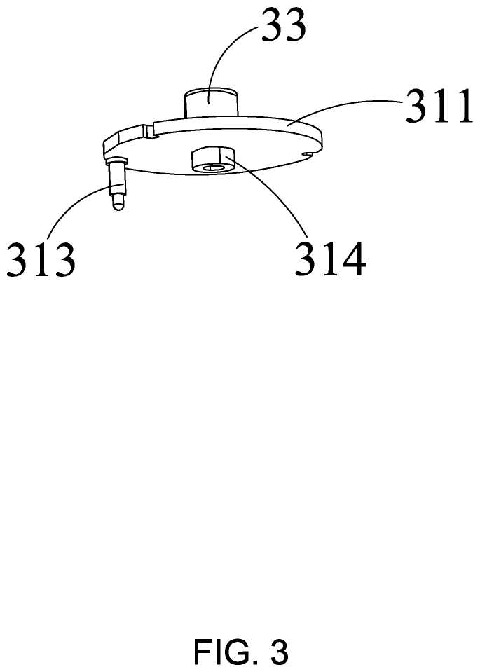

Referring to FIGS. 1 to 3, a rechargeable lithium battery assembly according to an embodiment of the present disclosure is shown. The lithium battery assembly 100 comprises a housing 10, a battery cell assembly 20 received in the housing 10 and a top cover assembly 30 encapsulated with one end of the housing 10. The battery cell assembly 20 has a cylindrical battery cell 200, a positive end 21 and a negative end 22 in the direction of the top cover assembly. While disassembled, the battery body 10 may be used as a power supply for external electronic products. The positive end 21 is provided on the central axis of the cylindrical battery cell. The negative end 22 is a ring around the outer circumference of the positive end 21. The top cover assembly 30 includes a circuit board assembly 31 placed on top of the cell assembly 20 and a top cover 32 encapsulated on the outside of the circuit board assembly 31. The circuit board assembly 31 includes a circuit board 311 for charging and discharging management, and a charging plug 36 is provided above the circuit board 311 and electrically connected to each other. The charging plug 36 is exposed outside the top cover 32 and may be folded and stored on the top cover 32.

In the present embodiment, the charging plug 36 may be a type-c component for small electronics such as smart phones. The charging plug 36 further has a foldable flexible wire 35, a type-C plug provided at one end of the flexible wire 35. The flexible wire 35 has a ring-shaped central portion 351, two branching arms 352 extending from the central portion 351 to both sides. The type-c plug being provided on one end of one of the two branching arms 352, and the end of the other branching arm is electrically connected to the battery cell assembly 20. The ring-shaped central portion 351 is made of a rigid, non-deformable material such as engineering plastic or metal, which is used as a skeleton supporter. The top cover 32 has a plate-shaped body, a tab 322 provided on the central area and overlaid with the ring-shaped central portion 351 of the flexible wire 35, and two slots 323 for holding the two branching arms 352, the central area of the tab 322 having a central hole 333. The flexible wire 35 is foldable without breaking. Obviously, the upper surface of the top cover 32 has a space for receiving the flex wire 35 and the type-c plug. While using, the type-C charging plug 36 is folded upward so that it protrudes outside the top cover 32 to facilitate plugging in and charging with external electronics.

In some embodiments, one of the two arms 352 is further provided with a touch switch 37 for triggering off the charging function, an LED (Lightt Emitting Diode) light 38 and a power indicator mark 39. These structures may be set either or both or all as needed. When with the above features, make the whole battery more humane and its use more convenient.

In some embodiments, the circuit board assembly 31 further includes a wireless charging coil 312 between the circuit board 311 and the top cover 32. The wireless charging coil 312 is electrically connected to the circuit board 311. The top surface of the top cover 32 is provided with a wireless charging marking ring 321. The wireless charging coil 312 is provided so that the battery cell has another way of charging, making it more selective and convenient for user. Furthermore, the wireless charging coil 312 may be a magnetic suction type wireless charging coil. Through the magnetic suction structure, it makes the connection between the battery and external electronic device more firmly when charging or discharging.

In some embodients, a positive cap 33 is provided upwardly in the center of the circuit board 311. The positive cap 33 passes upwardly through the center mounting portion 351 and the center hole of the tab 322 and extends outside the top cover 32. A negative ring 34 is stacked on the top surface of the ring-shaped central portion 351. The positive cap 33 and the negative ring 34 are insulated and spaced apart by the tab 322.

The electrical connection between the battery cell assembly 20 and the circuit board 311 is a detachable connection, which facilitates assembly and disassembly. Specifically, the battery cell assembly 20 includes a cell housing 23 and a battery core disposed in the core housing 23. The battery core may be one or at least two. The battery core may be connected in parallel or in series with each other. After the plurality of battery core are connected in parallel or in series by a nickel strip, them are then led out through a positive end 21 and a negative end 22. The positive end 21 is located at the center of the end face of the battery cell assembly 20, and the negative end 22 is provided around the periphery of the positive end 21. Obviously, the plurality of battery cores may be connected in series or parallel using aluminum foil, aluminum tape or copper foil. The number of the battery cores may be increased or decreased according to actual needs.

An electrical connecting unit 314 protrudes downward from the bottom center of the circuit board 311. The electrical connecting unit 314 is electrically connected to the positive cap 33, and the electrical connecting unit 314 is removably connected to the positive end 21 of the battery cell assembly 20.

As an improvement, the electrical connector 314 may be a nut, and the positive end 21 of the battery cell assembly 20 further has a stud, and the nut and stud are threaded together. Obviously, the position of the nut and the stud may be interchangeable. The bottom edge of the circuit board 311 protrudes downward from a resilient conductive post 313, and while the nut is threaded to the stud, the resilient conductive post 313 is connected to the negative end 22 of the battery cell assembly 20. The resilient conductive member 313 may be a resilient pin, a pop pin or a gold-plated copper post. By providing the resilient conductive member 313, the connection to the negative end 22 of the battery cell assembly 20 is made more secure.

In the present disclosure, The rechargeable lithium battery provided in this embodiment, using the above structure, the top cover is integrated within the Type-C charging plug, making it more flexible in use, more applications, and the overall internal structure is simple, low cost, easy to assemble, forming an improved battery alternative.

While the present disclosure has been described with reference to a specific embodiment, the description of the disclosure is illustractive and is not to be construed as limiting the disclosure. Various of modifications to the present disclosure can be made to the exemplary embodiment by those skilled in the art without departing from the ture spirit and scope of the disclosure as defined by the appended claims.

What is claimed is:

1. A rechargeable lithium battery assembly comprising:
a housing, a battery cell assembly, a top cover assembly encapsulated with one end of the housing, the cell assembly having a positive end and a negative end in the direction of the top cover assembly, the top cover assembly having a circuit board assembly and a top cover assembly for encapsulation, the circuit board assembly being electrically connected to the positive end and the negative end of the cell assembly, and wherein
the circuit board assembly has a circuit board, a charging plug provided on the circuit board and electrically connected thereto, the charging plug being extendable outside the top cover assembly and foldable for storage on the top cover assembly.

2. The rechargeable lithium battery assembly as described in claim 1, wherein the charging plug further has a foldable flexible wire, and a type-C plug is provided at one end of the flexible wire.

3. The rechargeable lithium battery assembly as described in claim 2, wherein the flexible wire has a ring-shaped central portion, two branching arms extending from the central portion to both sides, the type-c plug being provided on one of the two branching arms, the top cover assembly having a tab overlaid with the ring-shaped central portion of the flexible wire and two slots for holding the branching arms, the central area of the tab having a central hole.

4. The rechargeable lithium battery assembly as described in claim 3, wherein one of the two branching arms provided with a touch switch and/or LED light and/or a power indicator mark.

5. The rechargeable lithium battery assembly as described in claim 1, wherein the circuit board assembly further includes a wireless charging coil provided between the circuit board and the top cover assembly, the wireless charging coil electrically connected to the circuit board, a wireless charging logo is provided on the top surface of the top cover assembly.

6. The rechargeable lithium battery assembly as described in claim 5, wherein the wireless charging coil is a magnetic suction type wireless charging coil.

7. The rechargeable lithium battery assembly as described in claim 3, wherein a positive cap is located on the centre of the circuit board of the top cover assembly and is electrically connected to the positive end of the battery cell assembly, the positive cap is receiving in the central hole of the tab of the top cover assembly, a negative ring stacked in the ring-shaped central portion of the flexible wire, the positive post and the negative ring being insulated and spaced apart by the tab.

8. The rechargeable lithium battery assembly as described in claim 7, wherein the circuit board is provided with a downwardly extending electrical connecting unit, the electrical connecting unit is electrically connected by contacting with the positive end of the battery cell assembly.

9. The rechargeable lithium battery assembly as described in claim 8, wherein the electrical connection unit has a nut and a stud, the nut is removably connected to the stud.

10. The rechargeable lithium battery assembly as described in claim 9, wherein a resilient conductive post is provided extending downwardly at the bottom edge of the circuit board, the resilient conductive post abutting against the negative end of the battery cell assembly.

11. A rechargeable lithium battery assembly comprising:
a housing, a battery cell assembly, a top cover assembly encapsulated with the housing, the battery cell assembly having a cylindrical battery cell, a positive end and a negative end around the positive end, the top cover assembly having a circuit board assembly and a top cover assembly for encapsulation, the circuit board assembly being electrically connected to the positive end and the negative end of the cell assembly, and wherein
the circuit board assembly has a circuit board electrically connected to the top of the battery cell assembly;
a charging plug is electrically connected to the circuit board;
the top cover assembly is located above the circuit board;
the top cover assembly has a recess provided on the surface of the top cover assembly, the charging plug being at least partially housed in the recess and the charging plug being at least partially pulled out of the recess by external force.

12. The rechargeable lithium battery assembly as described in claim 11, wherein the charging plug further has a foldable flexible wire, and a type-C plug is provided at one end of the flexible wire.

13. The rechargeable lithium battery assembly as described in claim 12, wherein the flexible wire has a ring-shaped central portion, two branching arms extending from the central portion to both sides, the type-c plug being provided on one of the two branching arms.

14. The rechargeable lithium battery assembly as described in claim 13, wherein the top cover assembly has a tab overlaid with the ring-shaped central portion of the flexible wire and two slots for holding the branching arms, the central area of the tab having a central hole.

15. The rechargeable lithium battery assembly as described in claim 14, wherein a positive cap is located on the centre of the circuit board of the top cover assembly and is electrically connected to the positive end of the battery cell assembly, and a resilient conductive post is provided extending downwardly at the bottom edge of the circuit board for electrically connecting to the negative end of the battery cell assembly.

16. The rechargeable lithium battery assembly as described in claim 15, wherein the positive cap is received in the central hole of the tab and is exposed for electrical connecting to external electronic device.

17. The rechargeable lithium battery assembly as described in claim 16, wherein a negative ring is stacked on the top surface of the ring-shaped central portion of the flexible wire for electrical connecting to external electronic device.
